(19) United States
(12) Patent Application Publication
(10) Pub. No.: US 2026/0244422 A1
(43) Pub. Date: Aug. 20, 2026

(54) Automatic Update of Remote to Presentation Device

(71) Applicant: DISH Network L.L.C., Englewood, CO (US)

(72) Inventor: Eric Pleiman, Centennial, CO (US)

(73) Assignee: DISH Network L.L.C., Englewood, CO (US)

(21) Appl. No.: 19/055,699

(22) Filed: Feb. 18, 2025

(51) Int. Cl. G06F 8/61; H04L 67/00; H04N 21/4367

(52) U.S. Cl. CPC G06F 8/61; H04L 67/34; H04N 21/4367

(57) ABSTRACT

Devices, systems, and computer readable mediums facilitate remote control code updating for a host remote control device a new or updated sink device is added to a system. A staging server storing computer instructions which instantiate a sink code engine (SCE). The SCE configures the host to perform sink remote code retrieval operations including detecting a coupling of a given sink to the host, receiving sink data, searching for and retrieving sink remote data, and programming the host remote with the sink remote data. If unavailable, the the staging server is queried for the sink remote data and the sink remote data is retrieved from the staging server, and the host programs the host remote with the sink remote data. Upon such programming, the host remote can control at least one function of the sink device.

### TECHNICAL FIELD

The technology described herein generally relates to devices, systems, and processes which facilitate automatic updating of hosts and remote control devices utilized in conjunction with audio and video (“a/v”) systems, with current remote control codes utilized to control one or more a/v system components, such as televisions or other display devices, sounds systems, speakers, streaming media players, and the like.

### BACKGROUND

A/V systems commonly include one or more a/v devices, such as televisions, displays, speakers, a/v receivers, amplifiers and the like. A “host” device, such as a HOPPER set top box (“stb”), as provided by Dish Network L.L.C. of Englewood, Colorado, USA, is often utilized to integrate a/v devices into an a/v system and to control the one or more a/v devices in the given a/v system. The host will commonly be controlled using a universal remote control device (herein, a “host remote”) that has been programmed to control the host and one or more, if not each, of the a/v devices used in the given a/v system.

To provide universal remote control functions, the host commonly provides to the host remote (by a wireless upload or otherwise) with remote control codes that are utilized by one or more of the a/v device(s) in the given a/v system. Commonly, a user's a/v system will be updated, from time to time, to include one or more new or replacement a/v devices. For example, an a/v system may be expanded to include a streaming video stick or updated to include a new a/v device that replaces an existing a/v device. For a non-limiting example, a user may replace a 1080 p capable television with a new(er) 4K capable television. Commonly, the 1080 p television and the 4K television use different remote control codes for one or more corresponding functions of the given a/v device (e.g., the 1080 p television and the 4K television may utilize different remote control codes to control a volume setting). Accordingly, when a given a/v device is added (by addition or replacement) to a given a/v system, the host and the host remote commonly need to be updated with new remote control codes to operate the new a/v device. Given the numerous model, types, and the like of a/v devices available at any given time, a host often will not have readily available one or more remote control codes needed to operate one or more functions of a new a/v device.

Accordingly, when the new/replaced a/v device is added to the a/v system, a delay often occurs while the host seeks and finds from online servers, and then uploads to the host remote, the one or more remote control coded needed to utilize one or more functions/features of a given a/v device. Such delay can often be substantial. As used in the present application, a substantial delay is one of more than ten seconds, as measured from when the new a/v device is discovered by the host, to when the host remote is programmed with the one or more remote control codes needed to control the new a/v device.

Accordingly, devices, systems, methods and computer executable instructions are needed which facilitate an automated identifying, obtaining, storing, and providing of remote control codes for “new” a/v devices to a host and a host remote without incurring a substantial delay. As used herein, a given a/v device is “new” if it has been released by a manufacturer thereof, to the public for use thereby, within a period beginning six months or less before a coupling of the a/v device with the given host.

### SUMMARY

Various implementations are described of devices, systems, and processes for facilitating updating of remote control codes for new a/v devices on a host and a host remote.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

For at least one implementation of the present disclosure, a system may include a staging server, a host device coupled to the staging server, a host remote, coupled to the host device, configured to control at least the host device, and configurable to control one or more sink devices, and a given sink device. The host device includes a non-transitory host data store (HDS), a host device processor coupled to the HDS, a host remote interface coupling the host remote to the host device, and a host communications interface configured to couple the host device to the staging server and to the given sink device. For at least one implementation, the HDS non-transitorily stores first computer instructions which, when executed by the host processor, instantiate a sink code engine (SCE) which configures the host device to perform sink remote code retrieval operations (SRCRO).

For at least one implementation the SRCRO may include detecting a coupling of the given sink device to the host device, receiving sink data from the sink device, searching the HDS for sink remote data that corresponds to the sink data, retrieving, when available, the sink remote data from the HDS, and programming the host remote with the sink remote data. For at least one implementation, when the sink remote data is not available from the HDS, the SRCRO may include querying the staging server for the sink remote data, retrieving, when available, the sink remote data from the staging server, and programming the host remote with the sink remote data retrieved from the staging server. Upon programming the host remote with the sink remote data, the host remote includes at least one control code for controlling, using the host remote, at least one function of the sink device.

For at least one implementation, the sink data includes sink type data and the sink type data indicates a make, a model, a year, and a version of the given sink device.

For at least one implementation, the sink data includes sink capability data and the sink capability data indicates a High Bandwidth Digital Content Protection (HDCP) protocol supported by the sink device.

For at least one implementation, when the sink remote data is not available from the staging server, the SRCRO may include first identifying, to the sink device, one or more unsupported functions of the sink device, second identifying, to the sink device, supported functions of the sink device, and receiving, from the sink device, a configure instruction instructing the host device to configure the host remote to control one or more of the supported functions of the sink device.

For at least one implementation, when the configure instruction is received, the SRCRO may include retrieving, from the staging server, sink remote data corresponding to the one or more supported functions of the sink device and programming the host remote with the sink remote data retrieved from the staging server.

For at least one implementation, when the configure instruction is not received from the sink device, the SRCRO may include notifying the sink device that remote control of the sink device, using the host remote device, is unavailable for one or more unsupported functions of the sink device.

For at least one implementation, the host remote includes a host remote data store (HRDS) which non-transitorily stores second computer instructions which, when executed by the host processor, instantiate a sink control engine (SXE) which configures the host device to perform sink control operations (SXO).

For at least one implementation, the SXO may include detecting the given sink device coupled to the host device and determining if a given sink device control code, for the given sink device, is available in the HRDS.

For at least one implementation, when the given sink device control code is available in the HRDS, the SXO may include receiving a user input via the host remote, communicating the user input, by the host remote to the given sink device, using the given sink device control codes available in the HRDS, and receiving an indication, from the given sink device, that the user input was received.

For at least one implementation, the system may include a content source coupled to the host device and the SXO may include detecting the content source coupled to the host device and determining if content source control codes are available in the HDS. For at least one implementation, when content source control codes are available in the HDS, the SXO may include, when a user input for the content source is received at the host remote, receiving, by the host device from the host remote, a user input for the content source, communicating, by the host device to the content source, the user input using at least one of the content source control code available in the HDS, and receiving, by the host device from the content source, an indication that the user input was received.

For at least one implementation, when content source control codes are unavailable in the HDS, the SXO may include downloading content source control codes from the staging server and saving the content source control codes in the HDS.

For at least one implementation of the present disclosure, a non-transitory computer readable medium non-transitorily stores computer instructions which, when executed by a processor in a staging server, instantiates as a plurality of Cloud based services, a plurality of staging server retrieval engines (SSRE), including a given SSRE and a plurality of reminder SSREs, which configure the plurality of Cloud based services to independently and substantially simultaneously perform device code retrieval operations (DCRO).

For at least one implementation, the DCRO may include associating the given SSRE with a given device provider, associating each of the remainder SSRES with remainder device providers, generating, by the given SSRE, a legacy device database identifying at least one given legacy device for the given device provider, and generating, by each of the remainder SSREs, remainder legacy device databases respectively identifying remainder legacy devices for the remainder device providers.

For at least one implementation, the legacy device database and remainder legacy databases respectively include identifications of respective given legacy devices and remainder legacy devices and the DCRO may include determining, for each of the given legacy devices and the remainder legacy devices, if at least one device code operable to control a given function of the given legacy device and the remainder legacy devices is respectively available in one at least of the legacy device database and the remainder legacy device databases.

For at least one implementation, the given device provider provides at least one audio-visual presentation device.

For at least one implementation, the legacy device database and the remainder legacy databases are provided by a staging server data store (SSDS) accessible to the given SSRE and each of the remainder SSREs.

For at least one implementation, the legacy devices identified in the legacy device database include at least one host device and at least one sink device previously discovered by the given SSRE.

For at least one implementation, when a result of the determining does not result in an identification of a device code operable to control the given function of the given legacy device, the DCRO may include updating the legacy device database to identify the unavailable device code, and searching the Internet for an alternative device code that supports the given function of the given legacy device. When the alternative device code is found, the DCRO may include verifying the alternative device code supports the given function of the given legacy device.

For at least one implementation, the verifying that the alternative device code supports the given function of the given legacy device may include instantiating, by the staging server, as a second plurality of Cloud based services, a plurality of staging server testing engines (SSTE), including a given SSTE and a plurality of reminder SSTEs, which configure each of the second plurality of Cloud based services to independently and substantially simultaneously perform device code testing operations (DCTO).

For at least one implementation, the DCTO may include substantially simultaneously testing, using a set of SSTEs selected from the given SSTE and the plurality of remainder SSTEs, the alternative device code for the given legacy device is interoperable with at least one of the remainder of legacy devices.

For at least one implementation, the substantially simultaneous testing may include a first testing including a first population of host devices couplable with the given legacy device, a second testing including a second population of sink devices couplable with the given legacy device, and a third testing including a third population including plurality of combinations and permutations of the first population of host devices with the third population of sink devices. For at least one implementation the DCTO may include outputting a testing results message based on first results obtained by the first testing, second results obtained by the second testing, and third results obtained by the third testing.

For at least one implementation, the DCRO may include repeatedly searching the Internet, by the given SSRE, for a new device announcement by the given device provider and, when a new device announcement is found, adding, by the given SSRE, a new device identified in the new device announcement to a new device database maintained by a staging server data store (SSDS) accessible to the given SSRE.

For at least one implementation, the SSDS is accessible to each of the remainder SSRTEs.

For at least one implementation, when the new device announcement for the new device is found, the DCRO may include instantiating, by the staging server, as a second plurality of Cloud based services, a plurality of staging server testing engines (SSTE), including a given SSTE and a plurality of reminder SSTEs, which configure each of the second plurality of Cloud based services to independently and substantially simultaneously perform device code testing operations (DCTO) for the new device.

For at least one implementation, the DCTO may include substantially simultaneously testing, using a set of SSTEs selected from the given SSTE and the plurality of remainder SSTEs, at least one device code for the new device is interoperable with at least one of the remainder of legacy devices.

For at least one implementation, the DCRO may include publishing, by the given SSTE to the remainder SSTEs, a new device notice, publishing, by the given SSTE, the new device notice to one or more host devices, receiving, by at least one of the given SSTE, one or more requests from the one or more host devices to retrieve a new device code for the new device, and determining if the new device code for the new device is available in the SSDS.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of a system for automatic remote control updating and in accordance with at least one implementation of the present disclosure.

FIG. 2 is a schematic illustration of a host configured for use in the system of FIG. 1 and in accordance with at least one implementation of the system described in the present disclosure.

FIG. 3 is a schematic illustration of a host remote configured for use in the system of FIG. 1 and in accordance with at least one implementation of the system described in the present disclosure.

FIG. 4 is a schematic illustration of a staging server configured for use in the system of FIG. 1 and in accordance with at least one implementation of the system described in the present disclosure.

FIG. 5 is a flow diagram illustrating sink remote code retrieval operations performed by a sink configured for use in the system of FIG. 1 and in accordance with at least one implementation of the present disclosure.

FIG. 6 is a flow diagram illustrating sink control operations performed by a host configured for use in the system of FIG. 1 and in accordance with at least one implementation of the present disclosure.

FIG. 7 is a flow diagram illustrating device code retrieval operations performed by a staging server configured for use in the system of FIG. 1 and in accordance with at least one implementation of the present disclosure.

FIGS. 8A and 8B are flow diagrams illustrating device code testing operations performed by a staging server configured for use in the system of FIG. 1 and in accordance with at least one implementation of the present disclosure.

### DETAILED DESCRIPTION

Various implementations of the present disclosure describe devices, systems, and processes which facilitate automated updating of remote control codes used in conjunction with a host to control one or more a/v devices.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” (which are also commonly referred to as a “computer program”) herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like. For at least one implementation, an application may be configured as, include, and/or utilize a “plug-in” (as described below).

“AI/ML” (Artificial Intelligence/Machine Learning) herein refers to the use of one or more supervised learning, unsupervised learning, and/or refinement learning processes (as executed by one or more processors which may include processors associated with one or more neural networks) to perform one or more of the operations of the various computer engines described herein.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology rehosts which a given user does not actively manage or provide. A usage of a Cloud rehost may be private (limited to various users and/or uses), public (available for multiple users and/or uses), hybrid, dedicated, non-dedicated, or otherwise. An implementation may utilize Cloud rehosts using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud rehosts may be provided by one or more entities, such as AMAZON WEB SERVICES provided by Amazom.com Inc., AZURE provided by Microsoft Corp., and others.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.

“Content” and “Digital Content” (which are used interchangeably herein) refer to data that that may be presented, using a suitable presentation device, to a user in a humanly perceptible format. When presented to a human, the data becomes “information.” Non-limiting examples of content include text documents, spreadsheets, photos, videos, text messages, chat data, images, graphics, television programs, streaming video, music, or otherwise. Content may include, for example and not by limitation, one or more sounds, images, video, graphics, characters or otherwise. The content may originate from any host, including live and/or recorded, expanded reality, virtual reality, computer generated, or otherwise. The content may be presented to a given user using any user device and any user interface. Content may be stored, processed, communicated, or otherwise utilized. Content may identify artists, events, venues, and other aspects (as defined above).

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, HDMI, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient, non-transient, transitory and/or non-transitory form, as determined by any given state of such data, at any given time. For a non-limiting example, a given data packet may be non-transitory while stored in a storage device, but transitory during communication of the given data packet from a first device or system to a second (or more) device or system. As used herein and when received and stored in one or more of a cache, a memory, a data storage device, or otherwise, the given data packet has a non-transitory state. For example, and not by limitation, data may take any form and may be stored, in a data store, in a data file or other structure, hierarchy, or the like.

“Data store” herein refers to any device or combinations of devices, and/or components of a device, combinations of components of one or more devices, or the like configured to store data and computer instructions on a temporary, permanent, non-transitory, non-transient, and/or other basis. A data store is also referred to herein as a “computer readable medium” and/or a “non-transitory computer readable medium.” A data store may store data and computer instructions in any form, such as electrically, magnetically, physically, optically, or otherwise. A data store may include a cache on a processor, memory devices, or other physical component with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transitory data, computer instructions, or other the like may be suitably stored in a data store permanently or temporarily. As used herein, permanent storage is distinguished from temporary storage, with the latter providing a location for temporarily storing data, computer instructions, variables, or the like for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transitory and/or transient storage of data. Permanent storage and/or temporary storage may be used to store data and computer instructions which, while communicated may be transitory or transient, but while stored, is defined herein to be a form of non-transitory and non-transient data and/or computer instruction.

“Device” herein refers to any known or later arising electrical device configured to, singularly and/or in combination, communicate, manipulate, output (e.g., for presentation as information to a human), process, store, or otherwise utilize data. Non-limiting examples of devices include personal computers (e.g., a THINKPAD™ computer manufactured by Lenovo Corporation), table computing devices (e.g., an IPAD™ manufactured by Apple Inc. of Cupertino, California, USA), a smart phone (e.g., a GALAXY S24™ manufactured by Samsung Corporation), and other devices configured to enable a given user to provide edits to one or more instances of digital content.

“Instruction” (which is also referred to herein as a “computer instruction”) herein refers to a non-transitory processor executable instruction, associated data structures, sequence of operations, program modules, or the like. An instruction may be stored in a data store or otherwise for use and execution by a processor in a device, server, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient, non-transient, transitory and/or non-transitory basis, as may arise for any given data, content and/or instruction. While the computer code provided by one or more instructions is being utilized to instruct and/or configure a device, server, or the like to perform one or more than arising or later occurring operations, such use is herein deemed to occur on a non-transient and non-transitory basis.

“Module” herein refers to and, when claimed, recites definite structure for a device that is configured to provide at least one feature and/or output signal and/or perform at least one function including one or more of the features, output signals and functions described herein. A module may provide the one or more functions using computer engines, processors, computer instructions, applications, modules, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other hosts on an as-needed basis, or otherwise. Any known or later arising technologies may be used to provide a given module and the features and functions supported therein.

“Power Supply/Power Module/Power” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, multi-threaded, and otherwise.

“Security Component/Security Module/Security” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include content servers, database servers, file servers, application servers, web servers, communications servers, virtual servers, computing servers, and the like. Servers may be combined into clusters (e.g., a server farm), logically or geographically grouped, combined into neural networks, or otherwise configured and/or utilized. Any known or later arising technologies may be used for a server. A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configured to communicate data using a network, directly or indirectly, to another device, to another server, or otherwise.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay.

“User” herein refers to a single person and/or a group of users who are being presented, via a suitable user device, with a given content, which may include a current episode content and/or past episode content, at a given time.

“User Device (UD)” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, expanded reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, expanded reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Automated Remote Control Updating System 100

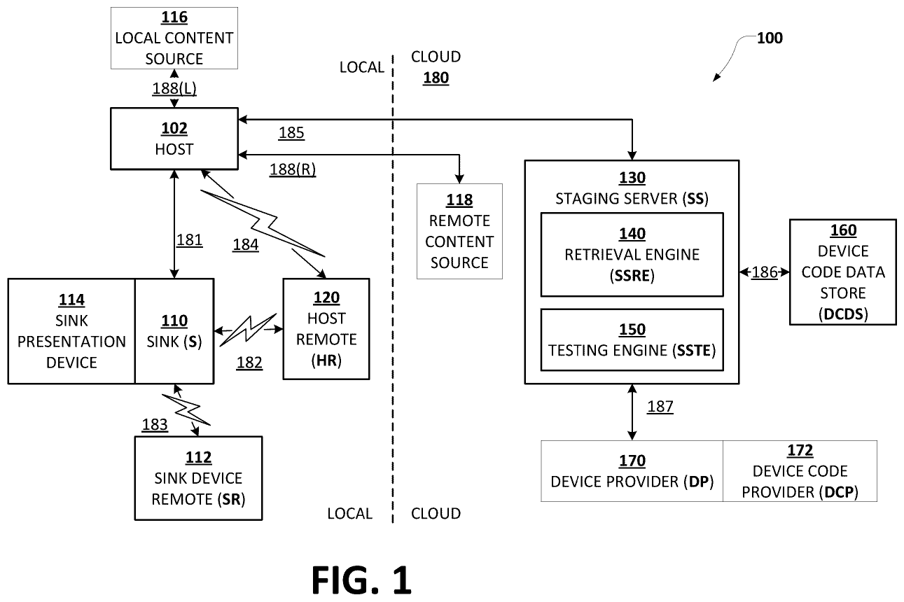

As shown in FIG. 1 and for at least one implementation of the present disclosure, an automated remote control updating system 100, may include one or more combinations and/or permutations of at least one host device (“H” or host) 102, at least one sink device (“S” or sink) 110, a sink remote (SR) 112, a host remote (HR)120, a staging server (SS) 130, at least one device code data store (DCDS) 160, at least one device provider (DP) 170 that includes and/or is coupled to a device code provider (DCP), and a network formed on the Cloud 180 and that include one or more couplings including: a first coupling 181 between the host 102 and the sink 110; a second coupling 182 between the sink 110 and the HR 120; a third coupling 183 between the sink 110 and the SR 112; a fourth coupling 184 between the host 102 and the HR 120; a fifth coupling 185 between the host 102 and the SS 130; a sixth coupling 186 between the SS 130 and the DCDS 160; and a seventh coupling 187 between the SS 130 and the DP 170 and DCP 172.

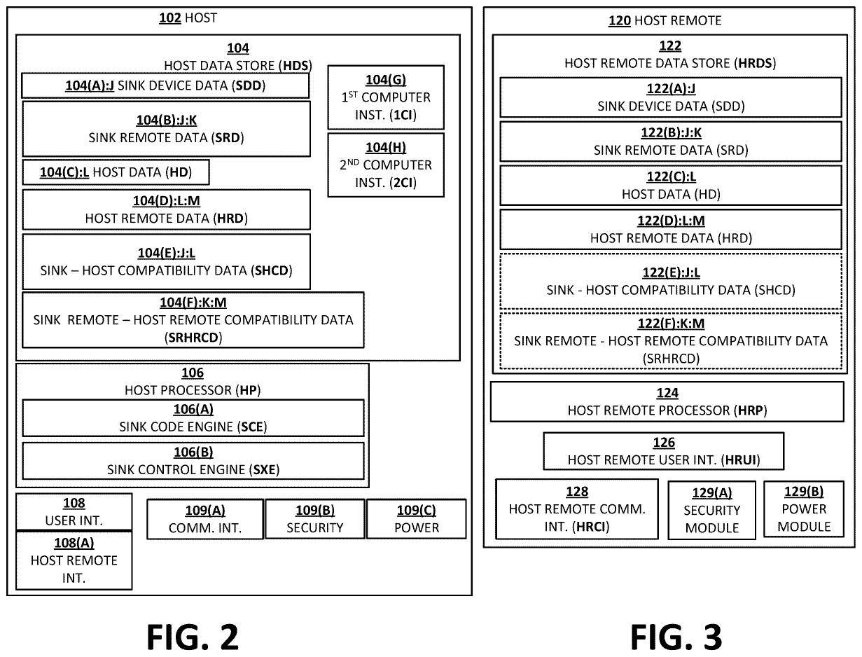

As shown in FIG. 2, the host (H) 102 may be configured to instantiate at least one sink code engine (SCE) 106(A) and at least one sink control engine (SXE) 106(B), as further described herein.

The staging server (SS) 130 may be configured to instantiate at least one SS retrieval engine (SSRE) 140 and at least one SS testing engine (SSTE) 150, a further described herein. For at least one implementation, the staging server 130 may be configured to implement AI/ML systems and processes to perform one or more functions of the SSRE 140 and/or the SSTE 150. The staging server (SS) 130, when configured to implement AI/ML systems and processes may include multiple servers that are centralized at a given data processing center and/or location and/or distributed across two or more data processing centers and/or locations. One or more of such data processing centers and/or locations may be provided on the Cloud or otherwise.

### Host (H) 102

As shown in FIGS. 1 and 2 and for at least one implementation, a host 102 may be coupled to one or more sinks(S) 110 (with one being shown in FIG. 1 for purposes of illustration only) and to the host remote (HR) 120. For at least one implementation, the host 102 may be a universal integration device configured to control, select, operate, enable, disable, or otherwise perform or instruct the performance of a feature or function provided by a sink 110 and/or other devices. For at least one implementation, a host 102 may be configured to retrieve content and provide such content for output by and presentation to a user via one or more sinks 110 and one or more presentation devices 114 provided with a given sink 110 or otherwise coupled to a given sink 110. Non-limiting examples of presentation devices 114 including televisions, video displays, sound systems, and the like.

One non-limiting example of a host 102 is a DISH HOPPER, as provided by Dish Network LLC of Englewood, Colorado, USA. Other non-limiting examples include home automation systems and processors, e.g., as provided under the CONTROL4 brand, such as the CORE 3 and CORE 5 processors by Snap One Inc. of Lehi, Utah, USA, and as provided under the SAVANT brand, as provided by Savant Systems, Inc. of Hyannis, Massachusetts, USA, and the like. Other non-limiting examples include GOOGLE NEST, SAMSUNG SMARTTHINGS, APPLE HOMEKIT and similar devices and systems configured to integrate the use of one or more sinks (SDs) 110 under a universal/integrated controller.

For at least one implementation, a host 102 may be configured to include a host data store (HDS) 104. The HDS 104 may be provided as any non-transitory “data store,” as described above, that non-transitorily stores data. The HDS 104 may be configured to store data in any logical, hierarchical, file system based, or other data storage architecture and/or structures.

For at least one implementation, data stored in the HDS 104 may include sink data (SDD) 104(A) and sink remote data (SRCD) 104(B). The sink data (SDD) 104(A) and sink remote data (SRD) 104(B) may be stored for one or more sinks 110, including “J” sinks 102, wherein “J” is an integer, and for one or more sink remote controls, including “K” remote controls that are configured for use with one or more of the given sinks, which is identified in FIG. 2 by “104(A):J” and wherein “K” is an integer. Accordingly, herein such given remote data 104(B), as stored in the HDS 104, is further identified in FIG. 2 by “104(B):J:K.” Other naming structures, hierarchical structures or the like may be used to establish a relationship between data corresponding to a given sink 104(A) and data corresponding to a given sink remote 104(B).

Any number of instances of sink data 104(A):J and sink remote data 104(B):J:K may be stored in the HDS 104 at any given time. For example, the sink data 104(A), as stored in the HDS 104, may include for a first sink 110(1), such as an audio amplifier, a first instance of sink data 104(A):1, while also storing for a second sink 110(2), such as a video monitor, a second instance of sink data 104(A):2.

For at least one implementation, and with respect to a given sink 110(J) coupled to a given host 102(L), the given host 102(L) may be configured to retrieve from the staging server 130 and store in the HDS 104, the given SDD 104(A):J, and the given SRD 104(B):J:K substantially simultaneously with the coupling of the given sink 110(J) with the given host 102(L). As used herein, substantially simultaneously means that the transfer of the given SDD 104(A):J and the given SRD 104(B):K occurs within two seconds from when the given sink 110 is coupled to the host 102(L), when the host 102(L) is already coupled to the staging server (SS) 130 by a 5th coupling 185 supporting data communications of 1 Mbps or greater, with less than 10 ms of latency, and the given sink data (SDD) 104(A):J combined with the given sink remote control data (SDRCD) 104(B):K contains less than 100 Mbits of data. Such substantial simultaneity, however, may take longer when less bandwidth, increased latency, and/or larger data packets are used.

As further shown in FIG. 2, the HDS 104 may be configured to store host data (HD) 104(C) for two or more hosts 102, as identified by the label “L” (wherein “L” is an integer) with such data being further identified in FIG. 2 by the label “104(C):L.” A given host 102(L) may be compatible with one or more instances, models, makes or the like of host remotes 120(M), wherein “M” is an integer and designates a given instance, make and/or model of a host remote 120 that is compatible with one or more given instances of a host 102. Accordingly, it is to be appreciated that a given host 102(L) may be compatible with one more given instances of a host remote 102(M), and data corresponding thereto may be stored in the HDS 104 as host remote control data (HRCD) as identified in FIG. 2 by the identifier “104(D):L:M.”

As further shown, the HDS 104 may be configured to store data indicative of which sink(s) 110 the given host 102 is compatible. Such data is herein identified as sink-host compatibility data (SHCD) 104(E) and may be further identified, logically related, hierarchically organized, or the like by an association of a given sink identifier 110(J) with a given host identifier 102(L) resulting in the identifier “104(E):J:L” being used herein for purposes of illustration in FIG. 2.

As further shown, the HDS 104 may be configured to store data indicative of which data, for a given sink remote 112, a given host remote 120 is compatible. Such data is herein identified as sink remote-host remote compatibility data (SRHRCD) 104(F) and may be further identified, logically related, hierarchically organized, or the like by an association of a given sink remote identifier 110(K) with a given host remote identifier 120(M) resulting in the identifier “104(F):K:M” being used herein for purposes of illustration in FIG. 2. For at least one implementation, a collection of device remote control data (and commands associated therewith) may include a set of data that is greater or lesser than a collection of host remote control data compatible with a given host remote 120. The SRHRCD 104(F) may identify which commands are compatible and incompatible with a given sink 110 and/or data used by a given sink remote 112. It is to be appreciated that a given user may desire to configure a system 100 such that some commands provided for a sink remote (SR) 112 may not be provided for use by the host remote (HR) 120 or vice versa. For example, commands facilitating a change in a parental control setting, with such commands being provided by via a sink remote (SR) 112, may not be provided for use by a given host remote (HR) 120.

As used herein, “system configuration data” refers to one or more combinations and/or permutations of SDD, SRD, HD, HRD, SHCD and SRHRCD, as may be non-transitorily stored, in a data store, at a given time.

As used herein, the designators (J), (K), (L), and (M) are used to indicate a given instance, version, configuration or the like of a sink (J), a sink remote (K), a host (L), and a host remote (M). The designators may be used in the system 100 such that data corresponding to unique instances of sinks, sink remotes, hosts, and host remotes may be stored in the HDS 104 and utilized thereby to facilitate the automated updating of a host 102 and a host remote 120 with control codes used to control a given sink 110 coupled to the host 102, at a given time.

The HDS 104 may be further configured to non-transitorily store 1^{st} computer instructions (1C1) in a 1C1 data store 104(G), the 1CI facilitating instantiation of a sink code engine (SCE) 106(A) when executed by a host processor (HP) 106, and second computer instructions (2CI) in a 2CI data store 104(H), the 2CI facilitating instantiation of a sink control engine (SXE) 106(B), when executed by the HP 106. Data for use by the SCE 106(A) and the SXE 106(B) may also be non-transitorily stored in the HDS 104.

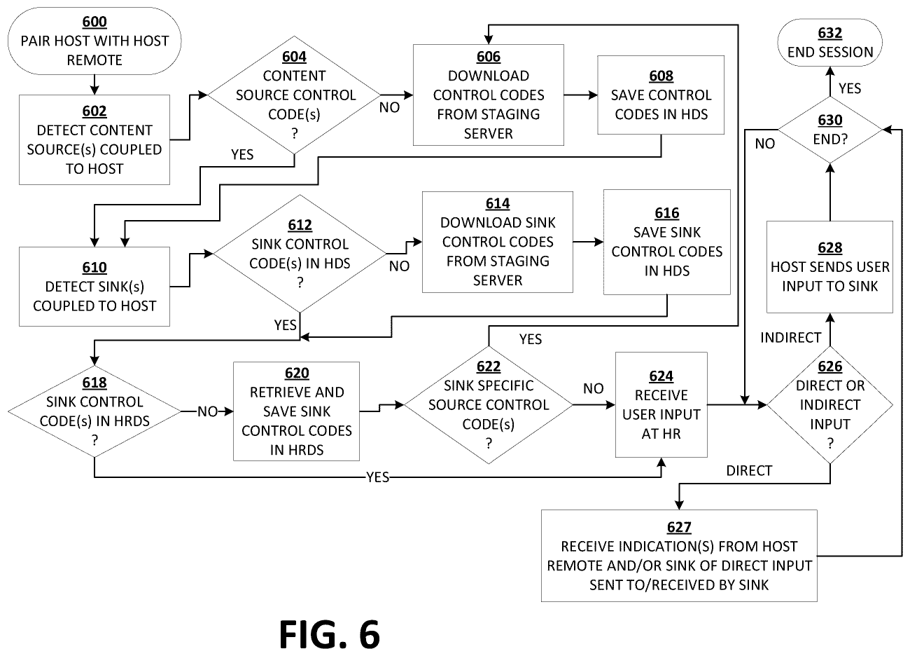

As shown in FIG. 2, the host 102 may include a host processor (HP) 106. The HP 106 may be a “processor” as described hereinabove. For at least one implementation, the HP 106 may be configured to execute the 1CI and thereby instantiate the SCE 106(A). The SCE 106(A) configures the host 102 to perform at least one sink remote code retrieval operation (SRCRO), as further described hereinbelow and with respect to FIG. 5. Upon retrieval of the one or more sink remote codes, the HP 106 may be configured to communicate such remote codes to the host remote (HR) 120, for use thereby, using known host to host remote 120 pairing and programming operations.

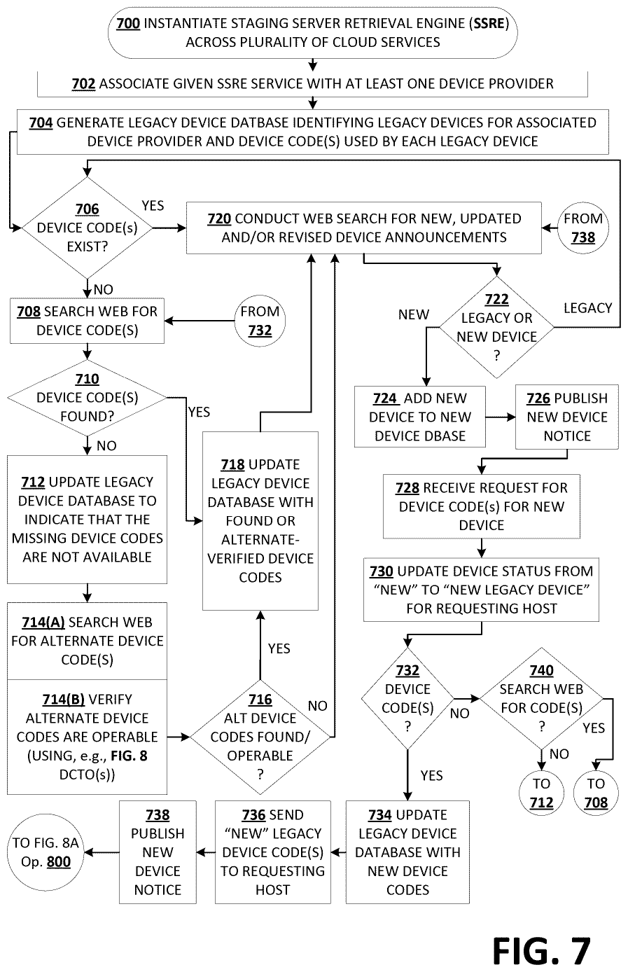

The HP 106 may be further configured to execute the 2CI and thereby instantiate the SXE 106(B). The SXE 106(B) configures the host 102 and the host remote 120 to perform at least one sink control operation (SXO), as further described hereinbelow and with respect to FIG. 6.

For at least one implementation, one or more of the 1CI and the 2CI may be non-transitorily stored by the HDS 104, on the Cloud, and/or otherwise and retrieved therefrom for use as needed and/or the 1CI and/or 2CI may be instructed to be executed by another processor in a distributed, virtualized, cooperative or other processing environment.

As shown in FIG. 2, the host 102 may include a user interface 108. The user interface 108 may be provided by and/or in addition to the host remote 120. The user interface 108 may support one or more additional, audio and/or video I/O interfaces, as described hereinabove. The host 102 may include a host remote interface 108(A) configured to establish and maintain the 4^{th} coupling 184. For at least one implementation, the 4^{th} coupling 184 may use radio frequency (RF) signals configured to be compatible with one or more known and/or later arising communications protocols including, but not limited to, WiFi®, BLUETOOTH, Z-WAVE, ZIGBEE, and the like. For at least one implementation, the 4^{th} coupling 184 may use infra-red (IR) signals. As further shown in FIG. 2, the 2^{nd} coupling 182 and/or the 3^{rd} coupling 183 may utilize RF and/or IR signals, with the 2^{nd} coupling 182 being compatible with couplings supported by the sink device 110 and wherein such couplings may or may not be supported by a given sink remote 112.

As further shown in FIG. 2, the host 102 may include a communications interface 109(A). The communications interface 109(A) may be a “communications interface” as described hereinabove. For at least one implementation, the communications interface 109(A) may configure, establish, support and/or otherwise utilize the 1^{st} coupling 181 as a wired coupling. The 1^{st} coupling may utilize any data protocol compatible with a given sink device 110. For a non-limiting example, an HDMI compatible coupling may be utilized when a given sink device 110 supports data communicated pursuant to a given HDMI protocol, such as HDMI 2.0, 2.1 and 2.2. For a least one implementation, HDMI 2.0 and greater protocols are utilized for the 1^{st} coupling 181. For another implementation, other protocols, such as HDBaseT, Ethernet, BLUETOOTH, and the like may be utilized with the 1^{st} coupling 181. The communications interface 109(A) may also configure, establish, support and/or otherwise utilize the 5^{th} coupling 185 between the host 102 and the staging server 130. Any form of suitable coupling may be utilized. For at least one implementation, the 5^{th} coupling 185 utilizes an Internet connection using Ethernet and related technologies.

As shown in FIG. 2, the host 102 may include a security module 109(B), which may be configured as described hereinabove. The host 102 may also include a power module 109(C) which may be configured as described hereinabove. The host 102 may further include one or more other modules, components, engines, applications, data stores, data files, computer instructions, or the like that are commonly provided with and/or coupled to a given host 102, which may be currently known and/or later developed and/or provided, and with respect to a given implementation of the present disclosure may be agnostic to and/or specifically configured to facilitate one or more implementations of the present disclosure. A bus (not shown) may couple the various host 102 components, modules and the like to each other. The bus may take any form and may use any commonly known in the art technologies and/or later arising technologies which couple one or more components of a device to one or more other components of the device.

### Sink (S) 110

As used herein, a sink (S) 110 includes any device controllable and/or accessible by and/or via use of a host 102. Non-limiting examples of a sink 110 include a/v devices, such as televisions, monitors, receivers, amplifiers, speakers, and the like, networking devices such as routers, gateways, modems, switches, and the like, data processing and storage devices, security devices, Internet-of-Things (IoT) compatible devices, mobile devices such as phones, tablets, and the like, and any other currently available and/or future arising device and/or collection of devices that may be controlled, directly or indirectly, by use of a host remote (HR) 120.

The sink 110 may be directly controlled via a sink remote (SR) 112. The sink 110 may be indirectly controlled via use of the host 102 and/or the host remote 120. It is to be appreciated that the host remote (HR) 120 may be utilized in lieu of the sink remote (SR) 112 so as to provide a unified and/or universal control element for system in which multiple sinks 110 are utilized with control of such multiple sinks 110 110 being provided via use of the host remote 120 directly and/or indirectly. Accordingly, it is to be appreciated that the sink remote (SR) 112 may not be utilized in accordance with at least one implementation of the present disclosure. The sink 110 may be configured to include (but are not shown in the drawing Figures) a data store, processor, communications interface, user interface, security module, power module and/or one or more other modules, components, engines, applications, data stores, data files, computer instructions, or the like that are commonly provided with and/or coupled to a given sink 110, which may be currently known and/or later developed and/or provided, and with respect to a given implementation of the present disclosure may be agnostic to and/or specifically configured to facilitate one or more implementations of the present disclosure. A bus (not shown) may couple the various sink 110 components, modules and the like to each other. The bus may take any form and may use any commonly known in the art technologies and/or later arising technologies which couple one or more components of a device to one or more other components of the device.

### Host Remote (HR) 120

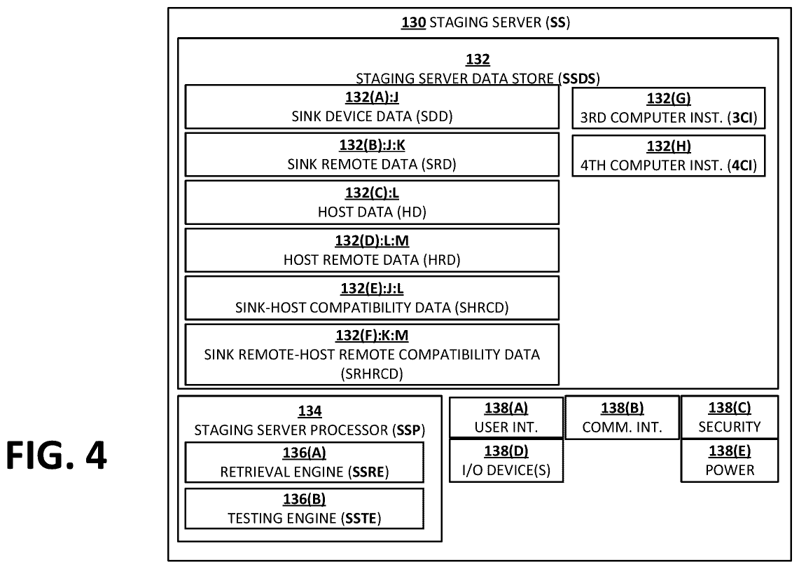

As shown in FIG. 3, the host remote (HR) 120 provides a user interface between the host 102, a user (not shown), and one/or more sinks 110 coupled to the host 102. As shown in FIG. 3 and for at least one implementation, the host remote (HR) 120 may be configured to include a non-transitory host remote data store (HRDS) 122. The HRDS 122 may configured to non-transitorily store data including, but not limited to: sink device data (SDD) 122(A):J; sink remote data (SRD) 122(B):K; host data (HD) 122(C):L; and host remote data (HRD) 122(D):L:M. For at least one implementation, the HRDS 122 may be configured to store sink-host compatibility data (SHCD) 122(E):J:L; and sink remote-host remote compatibility data (SRHRCD) 122(F):K:M. One or more instances of such data may be utilized to facilitate user control of the sink 110 by the communication of one or more remote control commands by the host remote (HR) 120, directly or indirectly, to the sink 110. For at least one implementation, the SDD, SRD, HD, HRD, SHCD and SRHRCD may mirror, duplicate and/or otherwise include one or more instances of such system configuration data as is stored, at a given time, on the HDS 104 or elsewhere by the system 100.

The host remote (HR) 120 may include a host remote processor (HRP) 124, which may a “processor” as described herein, a host remote user interface (HRUI) 126, which may be “user interface” as described herein, a host remote communications interface (HRCI) 128, which may be a “communications interface” as described herein, a security module 129(A), and a power module 129(B). The host remote 120 may include one or more other modules, components, engines, applications, data stores, data files, computer instructions, or the like that are commonly provided with and/or coupled to a given host remote 120, which may be currently known and/or later developed and/or provided, and with respect to a given implementation of the present disclosure may be agnostic to and/or specifically configured to facilitate one or more implementations of the present disclosure. A bus (not shown) may couple the various host remote 120 components, modules and the like to each other. The bus may take any form and may use any commonly known in the art technologies and/or later arising technologies which couple one or more components of a device to one or more other components of the device.

For at least one implementation, the HRP 124 may be configured to utilize the SDD, SRD, HD, and/or HRD based upon a configuration of the sink 110 and/or the sink presentation device 114 instructed by a given user at a given time. For example, a given user may instruct the HR 120 to configure one or more of the sink 110, the host 102 and/or the sink presentation device 114 to present a given content, as provided by one or more of a local content source 116 and/or a remote content source 118, at a given volume, and the like by the pressing or other selection of one or more user interface elements (e.g., a button press). Non-limiting examples of a local content source 116 may include a digital video recorder provided in and/or with a given host 102, a digital versatile disc (DVD) player, a file repository storing content on a local network, such as a local area network (LAN), or the like. Non-limiting examples of a remote content source 118 include a DISH Network broadcast center which provides a stream of content using a satellite, Internet or other communications medium, a streaming content services, such as NETFLIX, or the like. Any known and/or later arising local and/or remote content sources may be used in an implementation of the present disclosure. The HRP 124 may be programmed to utilize the stored system configuration data to provide commands to the system components, as needed to facilitate the presentation of the given content.

### Staging Server (SS) 130

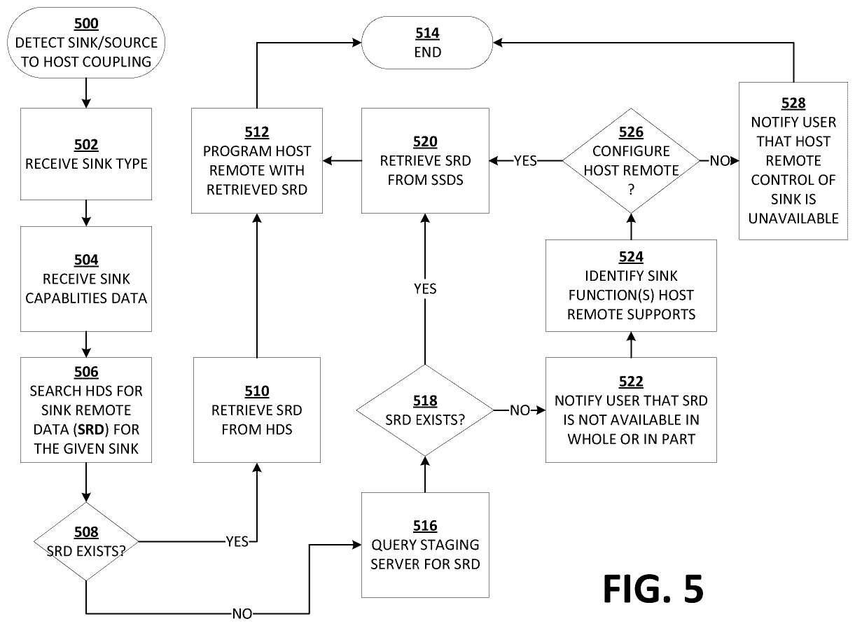

As shown in FIG. 4 and for at least one implementation, the staging server (SS) 130 may include a server data store (SSDS) 132. The SSDS 132 may configured to non-transitorily store data including, but not limited to: sink device data (SDD) 132(A):J; sink remote data (SRD) 122(B):K; host data (HD) 122(C):L; host remote data (HRD) 122(D):L:M; sink-host compatibility data (SHCD) 122(E):J;L; sink remote-host remote compatibility data (SRHRCD) 122(F):K:M; third (3^{rd}) computer instructions (3CI) 132(G); and fourth (4^{th}) computer instructions (4CI) 132(H). When executed by a staging server processor (SSP) 134, the 3CI 132(G) configures the SS 130 to instantiate a retrieval engine (SSRE) 136(A)—as described below. When executed by the SSP 134, the 4CI 132(H) configures the SS 130 to instantiate a testing engine (SSTE) 136(B)—as described below.

One or more instances of such system configuration data may be utilized to facilitate user control of the sink 110 by the communication of one or more remote control commands by the host remote (HR) 120, directly or indirectly, to the sink 110. For at least one implementation, the SDD, SRD, HD, HRD, SHCD, and SRHRCD may mirror, duplicate and/or otherwise include one or more instances of such system configuration data as is stored, at a given time, on the HDS 104, the HRDS 122, SSDS 132, on the Cloud 180, or elsewhere by the system 100. For at least one implementation, the SSDS 132 stores one or more instances of system configuration data that includes data for sinks 110, sink remotes 112, hosts, 102, and host remotes 120 that may not be utilized in a given implementation of system 100. For at least one implementation, the SSDS 132 may be configured to store instances of one or more of the system configuration data for each type of host 102 provided by a given provider of a system 100, such as the one or more types of HOPPER devices provided by and/or supported by DISH Network L.L.C. for use by its customers at a given time. It is to be appreciated that a given host 102 may include various versions of operating systems, configurations, upgrades, and the like. Accordingly, and for at least one implementation, the SSDS 132 may be configured to store multiple instances of system configuration data while a given HDS 104 and/or HRDS 122 may be configured to store one or more instances of system configuration data that relate to the given configuration of the HDS 104 and/or HRDS 122 utilized in that given implementation.

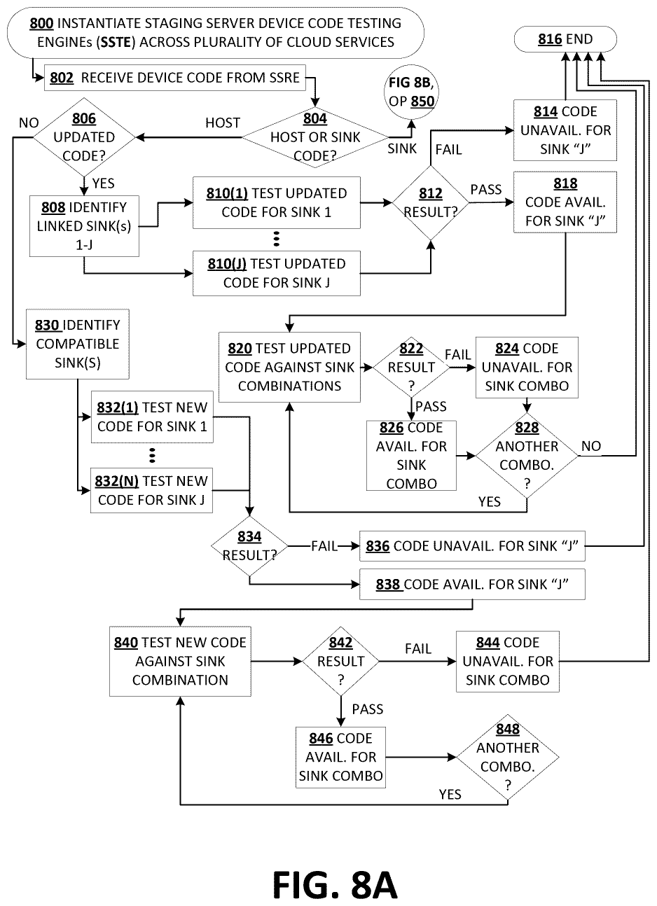

As shown in FIG. 4, the SS 130 includes the staging server processor (SSP) 134. The SSP 134 may be a “processor” as described hereinabove. For at least one implementation, the SSP 134 may be configured to execute the 3CI 132(G) and instantiate the SSRE 136(A). The SSRE 136(A) configures the SS 130 to perform device code retrieval operations (DCRO), as further described hereinbelow and with respect to FIG. 7.

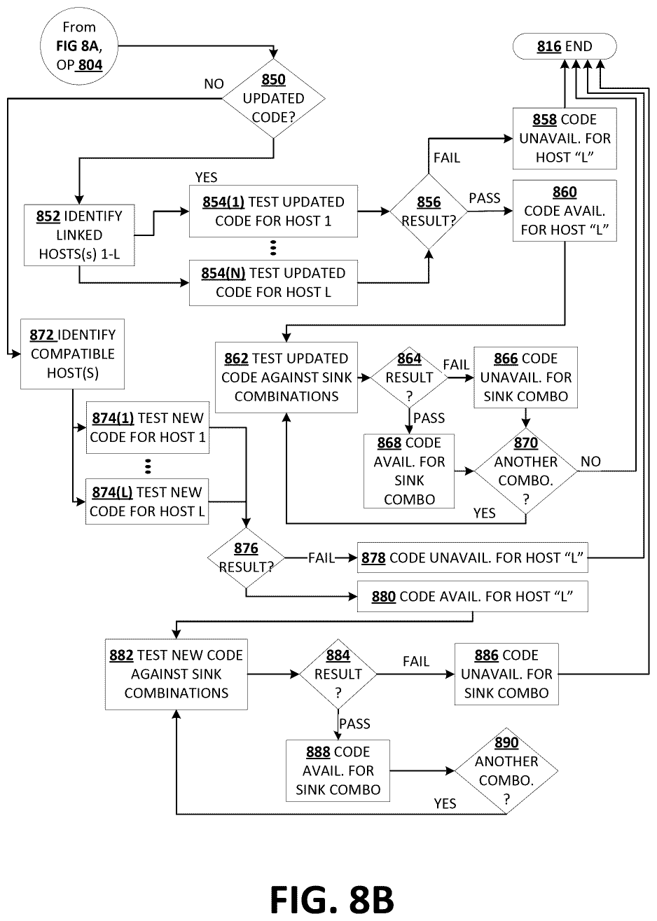

The SSP 134 may be configured to execute the 4CI 132(H) and thereby instantiate the SSTE 136(B). The SSTE 136(B) configures the SS 130 to perform at least one device code testing operation (DCTO), as further described hereinbelow and with respect to FIG. 8.

As shown in FIG. 4, the SS 130 may include a user interface 138(A). The user interface 138(A) may support one or more additional, audio and/or video I/O interfaces, as described hereinabove. The SS 130 may include a communications interface 138(B). The communications interface 138(B) may be a “communications interface” as described hereinabove. The SS 130 may include a security module 138(C), which may be configured as described hereinabove. The SS 130 may include one or more input/output devices 138(D), which may be configured as described hereinabove. The SS 130 may also include a power module 138(E) which may be configured as described hereinabove. The SS 130 may further include one or more other modules, components, engines, applications, data stores, data files, computer instructions, or the like that are commonly provided with and/or coupled to a given server, which may be currently known and/or later developed and/or provided, and with respect to a given implementation of the present disclosure may be agnostic to and/or specifically configured to facilitate one or more implementations of the present disclosure. A bus (not shown), network, or the like may couple the various SS 130 components, modules and the like to each other. The bus/network may take any form and may use any commonly known in the art technologies and/or later arising technologies which couple one or more components of a device to one or more other components of the device.

As shown in FIG. 5 and for at least one implementation of the present disclosure, a process for performing sink remote code retrieval operations (SRCRO) may include (herein, an “SRCRO process”), as per Operation 500, detecting a coupling a given sink 110 to a given host 102. It is to be appreciated that any known or later arising technologies, protocols, or the like may be used to couple a given sink 110 to a given host 102. For a non-limiting example, a presentation device (e.g., a video display such as a television) may be coupled to a given host 102 (e.g., a DISH HOPPER) using a wired coupling (e.g., an HDMI cable), a wireless coupling (e.g., WiFi, BLUETOOTH, or the like), a combination of wired/wireless couplings, or otherwise.

As per Operation 502 and for at least one implementation, the SCRCO process may include the host 102 receiving a sink data from the given sink 110. For at least one implementation, the sink data include “sink type data” refers to sink data that specifically identifies a given sink with non-limiting examples of such data including a make, model, year, version and/or other data that specifically identifies the given sink. For a non-limiting example, a television might be identified by a sink type of make=Samsung, model=QLED, year=2024 and version=QNX1D. For at least one implementation, Operation 502 may include an exchange of Consumer Electronics Control (“CEC”) protocol data between the given sink 110 and the given host 102.

As per Operation 504 and for at least one implementation, the SCRCO process may include the given host 102 receiving, from the given sink 110, sink data indicative of one or more capabilities of the given sink remote 112 (herein, “sink capability data”). For example, and not by limitation, the sink 110 may communicate Extended Display Identification Data (“EDID”) to the host 102. For another non-limiting example, the sink 110 may communicate to the given host 102 sink capability data indicative of which version of a High Bandwidth Digital Content Protection (“HDCP”) protocol the given sink 110 supports, and/or data indicative of other capabilities of the given sink 110.

As per Operation 506 and for at least one implementation, the SCRCO process may include the host 102 searching the HDS 104 for sink remote data (SRD) 104(B):J:K for the given sink “J.”.

As per Operation 508 and for at least one implementation, the SCRCO process may include determining whether SRD 104(B):J:K exists in the HDS 104. If “Yes,” the process may proceed to Operation 510. If “NO,” the process may proceed to Operation 516.

As per Operation 510 and for at least one implementation, the SCRCO process may include retrieving the SRD 104(B):J:K from the HDS 104.

As per Operation 512 and for at least one implementation, the SCRCO process may include programming the host remote with the retrieved SRD. Any known or later arising technologies may be used for programming the host remote with one or more sink device remote control codes.

As per Operation 514 and for at least one implementation, the SCRCO process may end with the host remote 120 being programmed with the one more sink remote control codes needed for the host remote 120 to control one or more, if not all, of the features and functions of the sink device 110 that would be otherwise controllable using a sink remote 112.

As per Operation 516 and for at least one implementation, the SCRCO process may include the host 102 querying the staging server (SS) 130 for the SRD.

As per Operation 518 and for at least one implementation, the SCRCO process may include the host 102 receiving an indication from the staging server 130 regarding whether the SRD exists, in whole or in part, in the SSDS 132. If “YES,” the process may proceed to Operation 520. If “NO,” the process may proceed to Operation 522.

As per Operation 520 and for at least one implementation, the SCRCO process may include the host 102 retrieving the available SRD from the SSDS. The process may then proceed to Operation 512.

As per Operation 522 and for at least one implementation, the SCRCO process may include the host 102 generating a message for communication to the user indicating that one or more instances of the SRD which would configure the host remote to operate the sink 110, in whole or in part, is unavailable.

As per Operation 524 and for at least one implementation, the SCRCO process may include the host 102 identifying one or more, if any, features and/or functions (herein, individually and collectively “functions”) provided by the sink 110 that the host remote supports. For example, a host remote may be configurable to support a power on/off and volume feature/function of the sink 110 but not an audio processing selection feature (e.g., DOLBY ATMOS audio processing being supported but THX audio processing not being supported).

As per Operation 526 and for at least one implementation, the SCRCO process may include the host 102 awaiting a user instruction as to whether to configure the host remote 120 with the sink functions identified per Operation 524. If “YES,” the process may proceed to Operation 520 wherein the host 102 retrieves, from the SSDS, the SRD that supports the reduced set of sink functions identified per Operation 524. If “NO,” the process may proceed to Operation 528.

As per Operation 528 and for at least one implementation, the SCRCO process may include the host 102 notifying the user that host remote control 120 of the sink 110 is unavailable. The process may then proceed to Operation 514 and End.

It is to be appreciated that the operations described above and depicted in FIG. 5 may be implemented in any given order, combination, in part, or otherwise.

As shown in FIG. 6 and for at least one implementation of the present disclosure, the SXE 106(B) configures the host 102 and the host remote 120 to perform sink control operations (SXO). As per Operation 600 and for at least one implementation, the SXO may include pairing the host 102 with the host remote 120. Any currently known and/or later developed pairing technologies may be utilized. For a given implementation, the pairing may occur using wireless technologies such as radio frequency, infrared, or the like.

As per Operation 602 and for at least one implementation, the SXO may include the host 102 detecting one or more local content sources 116 and/or remote content sources 118 coupled to the host 102. Any known and/or later arising content source discovery and/or detection technologies may be utilized in an implementation of the present disclosure.

As per Operation 604 and for at least one implementation, the SXO may include the host 102 determining if control codes for the content source(s) have been downloaded to the host 102. If “YES,” the process may proceed to Operation 610. If “NO,” the process may proceed to Operation 606. The control codes for a given content source may provide the host with the permissions, commands and the like needed by the host 102 to request, receive, process and perform one or more operations with respect to one or more instances of content. It is to be appreciated that such source control codes may be standardized, vary by source, or otherwise. Any known or later arising source control codes may be utilized in an implementation of the present disclosure.

As per Operation 606 and for at least one implementation, the SXO may include the host 102 downloading the one or more source control codes which the host 102 may utilize to control the retrieval, processing, and presentation one or more instances of content in conjunction with an implementation of the present disclosure. It is to be appreciated that the source control codes utilized may vary by content, sink 110 used, couplings used between the host 102 and the given content source, such as a local content source coupling 188(L) and/or a remote content source coupling 188(R).

As per Operation 608 and for at least one implementation, the SXO may include the host 102 storing the downloaded one or more source control codes in the HDS 104.

As per Operation 610 and for at least one implementation, the SXO may include the host 102 detecting one or more sinks 110 coupled to the host 102. Any known and/or later arising sink discovery and/or detection technologies may be utilized in an implementation of the present disclosure.

As per Operation 612 and for at least one implementation, the SXO may include the host 102 determining if the one or more sink control codes are stored in the HDS 104. If “YES,” the process may proceed to Operation 618. If “NO,” the process may procced to Operation 614.

As per Operation 614 and for at least one implementation, the SXO may include the host 102 downloading one or more sink control codes from the staging server 130. For at least one implementation, the SRCROs, as shown for example in FIG. 5 and discussed above, may be implemented.

As per Operation 616 and for at least one implementation, the SXO may include the host 102 saving the one or more sink control codes downloaded per Operation 614 in the HDS 104.

As per Operation 618 and for at least one implementation, the SXO may include the host 102 determining if the sink control codes to be utilized to operate and/or configure a given sink 110 have been stored in the host remote data store (HRDS) 122. If “YES,” the process may proceed to Operation 624. If “NO,” the process may proceed to Operation 620.

As per Operation 620 and for at least one implementation, the SXO may include the host 102 retrieving and saving one or more sink control codes into the HRDS. For at least one implementation, one or more of the SRCRO operations, as shown for example in FIG. 5 and discussed above, may be implemented.

As per Operation 622 and for at least one implementation, the SXO may include the host 102 determining if any sink specific source control codes are needed and have not been downloaded. If “YES,” the process may repeat Operation 606. If “No,” the process may include Operation 624.

As per Operation 624 and for at least one implementation, the SXO may include the host 102 detecting a user input has been provided at the HR 120.

As per Operation 626 and for at least one implementation, the SXO may include the host 102 determining if the user input is a direct input or an indirect input. As used in this context, a “direct input” refers to an input that is provided directly by the host remote 120 to a given sink 110. An “indirect input” refers to an input that is provided by the host remote 120 to the host 102 and then provided by the host 102 to a given content source 118 and/or a given sink 102. For at least one implementation, indirect inputs are used when a given user input is intended for a content source 118 and direct inputs are used when a given user input is intended for a given sink 110 that is communicatively coupled directly to the HR 120. If the user input is a direct input, the process may proceed to Operation 627. If the user input is an indirect input, the process may proceed to Operation 628. Non-limiting examples of user inputs, both direct and indirect, include volume change requests, channel change requests, content source change requests, picture format change requests, and the like.

As per Operation 627 and for at least one implementation, the SXO may include the host 102 awaiting receipt of one or more indications from the host remote 120 and/or from the sink 110 of the user input being directly sent by the host remote 120 to the sink 110 and/or of the sink 110 receiving the direct input. For at least one implementation, the indication may be a change in operating status communicated by the sink 110 to the host 102, a request for a change in a source selection or configuration received by the host 102 from the sink 110, or other form of message communicated between the host 102 and the sink 110 via, e.g., the first coupling 181.

As per Operation 628 and for at least one implementation, the SXO may include the host 102 sending the indirect input to the sink(s) and/or content source(s) identified by the indirect input.

As per Operation 630 and for at least one implementation, the SXO may include the host 102 determining whether host remote 120 control of one or more sinks 110 and/or content sources 118 is to end. For at least one implementation, such determination may be made in view of receipt of a “power off” command from the host remote 120, a lack of receipt of user inputs over a given period, or otherwise. If “YES,” the process proceeds to Operation 632 and ends. If “NO,” the process proceeds to Operation 626.

As shown in FIG. 7 and for at least one implementation of the present disclosure, device code retrieval operations (DCRO) performed by a staging server configured for use in the system of FIG. 1 may include, per Operation 700, instantiating a plurality of staging server retrieval engine (SSRE) 136(A) across a plurality of Cloud based services—as provided by one or more Cloud based staging servers. For at least one implementation, the SSREs 136(A) may be instantiated as multiple instances of an AI/ML engine that executes across multiple services provided by a Cloud based web service provider, such as AMAZON WEB SERVICES (AWS) or otherwise. The plurality of SSRE 136(A) services may be configured to perform device code retrieval operations with respect to numerous currently existing and later arising host 102 and/or sink 110 device providers, with non-limiting examples of host device providers including DISH, GOOGLE, AMAZON, APPLE, and others, and with non-limiting examples of sink device providers including AMAZON, GOOGLE, DISH, ROKU, SAMSUNG, TOSHIBA, LG, DENON, ONKYO, SONY, PIONEER, SANOS, and others. It is to be appreciated that at any given time a universe of host and sink device providers may number in the thousands.

As per Operation 702 and for at least one implementation, the DCRO may include associating a given SSRE service (of which there may be one or more at any given time, with each SSRE service performing respective DCROs) with a given device provider. The given device provider may be a host device provider and/or a sink device provider. One or more device providers may be associated with a given SSRE service and multiple SSRE services may be associated with a given device provider that provide numerous types and models of host and/or sink devices with one non-limiting example of such a device provider including SONY which provides host devices, such as the SONY PLAYSTATION, and sink devices, such as a SONY television.

As per Operation 704 and for at least one implementation, the DCRO may include generating a legacy device database identifying one or more legacy devices provided by the device provider(s) associated with the SSRE service(s) per Operation 702. For at least one implementation, the legacy device database may be stored in the DCDS 160. As used herein, a “legacy device” includes any host and/or sink device that has been previously discovered by an SSRE (such discovery being described further hereinbelow). The legacy database may also include an identification of a given device and the one or more device code(s) operable therewith. It is to be appreciated that a given device code may operate across multiple instances of devices. For example, a SAMSUNG power-on/power-off device code may be operable across multiple instances of televisions provided by SAMSUNG.

As per Operation 706 and for at least one implementation, the DCRO may include verifying that one or more device codes identified in the legacy device database exists or are otherwise available for retrieval from the DCDS 160. If “NO,” the process may proceed to Operation 708. If “YES,” the process may proceed to Operation 720.

As per Operation 708 and for at least one implementation, the DCRO may include searching the Web for the missing device code(s). The web search may include a search of a website provided by the device provider or other providers.

As per Operation 710 and for at least one implementation, the DCRO may include determining if the missing device codes have been found. If “NO,” the process may proceed to Operation 712. If “YES,” the process may proceed to Operation 714.

As per Operation 712 and for at least one implementation, the DCRO may include updating the legacy device database to indicate that the missing device codes are not available from the device provider.

As per Operation 714(A) and for at least one implementation, the DCRO may include the DCRO service(s) executing a web search for alternative device code(s) that provide the missing functionality otherwise provided by the missing device codes and, per Operation 714(B), verifying any alternative device codes found per Operation 714(A) are operable for providing the missing functionality. For at least one implementation, the verification(s) performed per Operation 714(B) may include performing of one or more of the device code testing operations (DCTO) performed by one or more instances of a staging server testing engine (SSTE) as described below in conjunction with the process shown in FIG. 8.

As per Operation 716 and for at least one implementation, the DCRO may include the one or more DCRO service(s) verifying that alternate and operable device code(s) have been found and verified. If “YES,” the process may proceed to Operation 718. If “NO,” the process may proceed to Operation 718 with the status of the missing devices codes (as updated per Operation 712) remaining as not available in the legacy device database.

As per Operation 718 and for at least one implementation, the DCRO may include updating the legacy device database as indicating that one or more of the missing device codes have been found or that an alternate device code has been found and verified.

As per Operation 720 and for at least one implementation, the DCRO may include the one or more DCRO service(s) conducting Web searches for new, updated and/or revised announcements regarding one or more host and/or sink devices (herein, each such announcement being a “device announcement”) by the given device provider. The Web searches may occur on any periodicity, frequency, on demand, or otherwise. The Web searches may include multiple DCRO services searching multiple Web servers for device announcements.

As per Operation 722 and for at least one implementation, the DCRO may include, when a device announcement is found, determining whether the device announcement is for a legacy device or a new device, wherein a “new device” is any device not previously identified in the legacy device database. If the device announcement is for a legacy device, the process may proceed to Operation 706. If the device announcement is for a new device, the process may proceed to Operation 724.

As per Operation 724 and for at least one implementation, the DCRO may include adding the new device to at least one instance of a “new device” database. For at least one implementation, one or more instances of the new device database may be provided by the DCDS 160. Devices identified in a given instance of the new device database, of which there may be many, may be identified on a host device basis such that a new device is designated as “new” versus “legacy” until a given host seeks to retrieve one or more device codes for the so designated “new device” from the DCDS 160.

As per Operation 726 and for at least one implementation, the DCRO may include the staging server 130 publishing a notice (herein, a “new device notice”) to the one or more host devices coupled thereto that a “new device” being added to one or more given new device databases.

As per Operation 728 and for at least one implementation, the DCRO may include receiving a request from a given host device to retrieve one or more device codes for a “new device” from the DCDS 160.

As per Operation 730 and for at least one implementation, the DCRO may include updating a device status, with respect to a given host 102, and with respect to a given “new device” as being a “new legacy device” with a corresponding updating, in the DCDS 160, of the device status. It is to be appreciated that numerous instances of “new device” and “new legacy device” database listing may exist at any given time and each such instance may be associated with a given host device. A given host 102 may be associated with a given DCRO service so that an identification of the new device and legacy device database listings to be utilized, by the given host 102, may be managed by the staging server 130 and the DCDS 160.

As per Operation 732 and for at least one implementation, the DCRO may include determining whether the one or more device codes for the previously designated “new device” (such device code(s) being requested by a given host 102 as per Operation 728) exist in the DCDS 160. If “YES,” the process may proceed to Operation 734. If “NO,” the process may proceed to Operation 740.

As per Operation 734 and for at least one implementation, the DCRO may include updating the legacy device database listing associated with the given, requesting, host to identify the requested (and already available device codes).

As per Operation 736 and for at least one implementation, the DCRO may include communicating such “new” device codes to the requesting host 102 (as so requested per Operation 728).

As per Operation 738 and for at least one implementation, the DCRO may include publishing a notice (herein, a “new device code notice”) to the one or more host devices coupled thereto that one or more devices codes for a “new device” have been added to one or more given new device databases. The process may proceed to FIG. 8, Operation 800.

For at least one implementation, the DCRO may be trained for AI/ML implementation by initially using a supervised learning phase followed by a refinement learning phase. During the supervised learning phase, a “technician” (which may be a person or an automated process) oversees the identifying of devices as “new” or “legacy” and the association of device codes with such devices. The technician may further train the AI/ML model by reviewing web searches for device codes for the given device and, based on the testing results provided by the DCTO, verifying such device codes instruct a given device to perform one or more of the operations associated therewith (e.g., raise/lower volume, change channel, or otherwise). For at least one implementation, the supervised learning phase may include performing the DCROs with respect to ten (10) hosts 102 and one-hundred (100) sinks 110, and with respect to at least ten (10) device codes for each such host 102 and sink 110 combination and permutation of a given host 102 with multiple sinks 110. Based upon results obtained during the supervised learning phase, the numerous instances of the staging server 130 instantiating the DCRO services may enter into a refinement phase wherein feedback from host users and others identify instance where a given device code is not available, or otherwise inoperable with respect to one or more given hosts and/or sinks. Based upon such feedback, the processes of FIG. 7 may be reperformed until, if ever, one or more verified (as per the DCTOs of FIG. 8) device codes are available for use by one or more given hosts 102 to control one or more given features and/or functions of a given sink 110.

As shown in FIGS. 8A and 8B and for at least one implementation of the present disclosure, device code testing operations (DCTO) performed by a staging server configured for use in the system of FIG. 1 may include, per Operation 800, instantiating a plurality of staging server testing engines (SSTEs) 136(B) across a plurality of Cloud based services-as provided by one or more Cloud based staging servers 130. For at least one implementation, the SSTEs 136(B) may be instantiated as multiple instances of an AI/ML engine that executes across multiple services provided by a Cloud based web service provider, such as AMAZON WEB SERVICES (AWS) or otherwise. The plurality of SSTEs 136(B) services may be configured to perform device code testing operations for one or more “new” device codes, as retrieved by an SSRE 136(A) in accordance with at least one implementation of the present disclosure and as discussed above with respect to FIG. 7.

As per Operation 802 and for at least one implementation, the DCTO process may include receiving a device code from the SSRE (as per FIG. 7).

As per Operation 804 and for at least one implementation, the DCTO process may include determining if the device code is for a host device or a sink device. If for a sink device, the process may proceed to FIG. 8B, Operation 850. If for a host device, the process may proceed to Operation 806.

As per Operation 806 and for at least one implementation, the DCTO process may include determining if the device code is an updated code. If “Yes,” the process may proceed to Operation 808. If “No,” indicating that the device code is a new code, the process may proceed to Operation 830.

As per Operation 808 and for at least one implementation, the DCTO process may include identifying one or more “J” sinks that have been linked to the host device (as per one or more of Operations 718 or 734).

As per Operation 810(1−J) (which may be repeated for up to “J” sinks) and for at least one implementation, the DCTO process may include testing the updated code for a given sink (1−J).

As per Operation 812 and for at least one implementation, the DCTO process may include determining a result of the updated code testing. If the testing fails, the process may proceed to Operation 814. If the testing passes, the process may proceed to Operation 818.

As per Operation 814 and for at least one implementation, the DCTO process may include designating the updated code as being unavailable for sink “J”.

As per Operation 816 and for at least one implementation, the DCTO process may end.

As per Operation 818 and for at least one implementation, the DCTO process may include designating the updated code as being available for sink “J.”

As per Operation 820 and for at least one implementation, the DCTO process may include the process may include testing the updated code against sink combinations. For example, a given host 102 may be coupled to a first sink, such as a display device, and a second sink, such as sound system. Accordingly, the updated code may be tested against the combination of the first sink and the second sink to verify interoperability of the updated host with numerous combinations of sink devices couplable to the given host.

As per Operation 822 and for at least one implementation, the DCTO process may include determining a result of the updated code testing against a designated combination of sink device. If the testing fails, the process may proceed to Operation 824. If the testing passes, the process may proceed to Operation 818.

As per Operation 824 and for at least one implementation, the DCTO process may include designating the updated code as being unavailable for the given sink combination.

As per Operation 826 and for at least one implementation, the DCTO process may include designating the updated code as being available for the designated sink combination.

As per Operation 828 and for at least one implementation, the DCTO process may include determining whether to test the updated code against another sink combination. If “Yes,” the process may repeat one or more of operations 820-828. If “No,” the process may end, per Operation 816.

As per Operation 830 and for at least one implementation, the DCTO process may include identifying compatible sinks for a new host 102 device.

As per Operation 832(1−J) (which may be repeated for up to “J” sinks) and for at least one implementation, the DCTO process may include testing the new host devic code for a given sink (1−J).

As per Operation 834 and for at least one implementation, the DCTO process may include determining a result of the new host code testing. If the testing fails, the process may proceed to Operation 836. If the testing passes, the process may proceed to Operation 838.

As per Operation 836 and for at least one implementation, the DCTO process may include designating the new code as being unavailable for sink “J”.

As per Operation 838 and for at least one implementation, the DCTO process may include designating the new host code as being available for sink “J.”

As per Operation 840 and for at least one implementation, the DCTO process may include the process may include testing the new code against sink combinations.

As per Operation 842 and for at least one implementation, the DCTO process may include determining a result of the new host code testing against a designated combination of sink device. If the testing fails, the process may proceed to Operation 844. If the testing passes, the process may proceed to Operation 846.

As per Operation 844 and for at least one implementation, the DCTO process may include designating the new host code as being unavailable for the given sink combination.

As per Operation 846 and for at least one implementation, the DCTO process may include designating the new host code as being available for the designated sink combination.

As per Operation 848 and for at least one implementation, the DCTO process may include determining whether to test the new code against another sink combination. If “Yes,” the process may repeat one or more of operations 840-848. If “No,” the process may end, per Operation 816.

As shown in FIG. 8B, Operation 850 and for at least one implementation, the DCTO process may include determining if the device code is an updated code. If “Yes,” the process may proceed to Operation 852. If “No,” indicating that the device code is a new code, the process may proceed to Operation 872.

As per Operation 852 and for at least one implementation, the DCTO process may include identifying one or more “L” hosts that have been linked to the sink device (as per one or more of Operations 718 or 734).

As per Operation 854(1−L) (which may be repeated for up to “L” hosts) and for at least one implementation, the DCTO process may include testing the updated code for a given host (1−L).

As per Operation 856 and for at least one implementation, the DCTO process may include determining a result of the updated code testing. If the testing fails, the process may proceed to Operation 858. If the testing passes, the process may proceed to Operation 860.

As per Operation 858 and for at least one implementation, the DCTO process may include designating the updated code as being unavailable for host “L”.

As per Operation 816 and for at least one implementation, the DCTO process may end.

As per Operation 860 and for at least one implementation, the DCTO process may include designating the updated code as being available for host “L”.

As per Operation 862 and for at least one implementation, the DCTO process may include the process may include testing the updated code against sink combinations. For example, a given host 102 may be coupled to a first sink, such as a display device, and a second sink, such as sound system. Accordingly, the updated code may be tested against the combination of the updated sink, with a given host and one more second sinks couplable to the given host to verify interoperability of the host with numerous combinations of the updated sink and other sink devices couplable to a given host.

As per Operation 864 and for at least one implementation, the DCTO process may include determining a result of the updated sink code testing against a designated combination of host and sink devices. If the testing fails, the process may proceed to Operation 866. If the testing passes, the process may proceed to Operation 868.

As per Operation 866 and for at least one implementation, the DCTO process may include designating the updated code as being unavailable for the updated sink, host and additional one or more sink combination.

As per Operation 868 and for at least one implementation, the DCTO process may include designating the updated sink code as being available for the designated sink, host and additional sink combinations.

As per Operation 870 and for at least one implementation, the DCTO process may include determining whether to test the updated code sink against another sink, host, and additional sink combination. If “Yes,” the process may repeat one or more of operations 862-870. If “No,” the process may end, per Operation 816.

As per Operation 872 and for at least one implementation, the DCTO process may include identifying compatible hosts for a new sink 102 device.

As per Operation 874(1−L) (which may be repeated for up to “L” hosts) and for at least one implementation, the DCTO process may include testing the new sink host device code for a given host (1−L).

As per Operation 876 and for at least one implementation, the DCTO process may include determining a result of the new sink code testing. If the testing fails, the process may proceed to Operation 878. If the testing passes, the process may proceed to Operation 880.

As per Operation 878 and for at least one implementation, the DCTO process may include designating the new sink code as being unavailable for host “L”.

As per Operation 880 and for at least one implementation, the DCTO process may include designating the new sink code as being available for host “L.”

As per Operation 882 and for at least one implementation, the DCTO process may include the process may include testing the new sink code against sink, host and additional sink combinations.

As per Operation 884 and for at least one implementation, the DCTO process may include determining a result of the new sink code testing against a designated combination of sink, host and additional sink device(s). If the testing fails, the process may proceed to Operation 886. If the testing passes, the process may proceed to Operation 888.

As per Operation 886 and for at least one implementation, the DCTO process may include designating the new sink code as being unavailable for the given sink, host and additional sink combination.

As per Operation 888 and for at least one implementation, the DCTO process may include designating the new sink code as being available for the designated sink, host and additional sink combination.

As per Operation 890 and for at least one implementation, the DCTO process may include determining whether to test the new sink code against another sink, sink and additional host combination. If “Yes,” the process may repeat one or more of operations 882-890. If “No,” the process may end, per Operation 816.

For at least one implementation, the DCTO may be trained for AI/ML implementation by initially using a supervised learning phase followed by a refinement learning phase. During the supervised learning phase, a “technician” (which may be a person or an automated process) oversees the identifying of devices as “new” or “legacy” and the association of device codes with such devices. The technician may further train the AI/ML model by reviewing web searches for device codes for the given device and, based on the testing results provided by the DCTO, verifying such device codes instruct a given device to perform one or more of the operations associated therewith (e.g., raise/lower volume, change channel, or otherwise). For at least one implementation, the supervised learning phase may include performing the DCTOs and DCTOs with respect to ten (10) hosts 102 and one-hundred (100) sinks 110, and with respect to at least ten (10) device codes for each such host 102 and sink 110 combination and permutation of a given host 102 with multiple sinks 110. Based upon results obtained during the supervised learning phase, the numerous instances of the staging server 130 instantiating the DCTO services may enter into a refinement phase wherein feedback from host users and others identify instance where a given device code is not available, or otherwise inoperable with respect to one or more given hosts and/or sinks. Based upon such feedback, the processes of FIGS. 7, 8A and 8B may be reperformed until, if ever, one or more verified (as per the DCTOs of FIG. 8) device codes are available for use by one or more given hosts 102 to control one or more given features and/or functions of a given sink 110 and/or a combination of sinks.

It is to be appreciated that the operations described above and depicted in FIGS. 5-8 may be implemented in any given order, combination, in part, or otherwise.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A system comprising:
a staging server;
a host device coupled to the staging server;
a host remote, coupled to the host device, configured to control at least the host device, and configurable to control one or more sink devices; and
a given sink device;
wherein the host device comprises:
a non-transitory host data store (HDS);
a host device processor coupled to the HDS;
a host remote interface coupling the host remote to the host device; and
a host communications interface configured to couple the host device to the staging server and to the given sink device;
wherein the HDS non-transitorily stores first computer instructions which, when executed by the host processor, instantiate a sink code engine (SCE) which configures the host device to perform sink remote code retrieval operations (SRCRO) comprising:
detecting a coupling of the given sink device to the host device;
receiving sink data from the sink device;
searching the HDS for sink remote data that corresponds to the sink data;
retrieving, when available, the sink remote data from the HDS; and
programming the host remote with the sink remote data; and
wherein, when the sink remote data is not available from the HDS, the SRCRO further comprise:
querying the staging server for the sink remote data;
retrieving, when available, the sink remote data from the staging server; and
programming the host remote with the sink remote data retrieved from the staging server; and
wherein upon programming the host remote with the sink remote data, the host remote includes at least one control code for controlling, using the host remote, at least one function of the sink device.

2. The system of claim 1,
wherein the sink data includes sink type data; and
wherein the sink type data indicates a make, a model, a year, and a version of the given sink device.

3. The system of claim 2,
wherein the sink data includes sink capability data; and
wherein the sink capability data indicates a High Bandwidth Digital Content Protection (HDCP) protocol supported by the sink device.

4. The system of claim 1,
wherein, when the sink remote data is not available from the staging server, the SRCRO further comprise:
first identifying, to the sink device, one or more unsupported functions of the sink device;
second identifying, to the sink device, supported functions of the sink device; and
receiving, from the sink device, a configure instruction instructing the host device to configure the host remote to control one or more of the supported functions of the sink device.

5. The system of claim 4,
wherein, when the configure instruction is received, the SRCRO further comprise:
retrieving, from the staging server, sink remote data corresponding to the one or more supported functions of the sink device; and
programming the host remote with the sink remote data retrieved from the staging server.

6. The system of claim 5,
wherein, when the configure instruction is not received from the sink device, the SRCRO further comprise:
notifying the sink device that remote control of the sink device, using the host remote device, is unavailable for one or more unsupported functions of the sink device.

7. The system of claim 1, further comprising:
wherein the host remote includes a host remote data store (HRDS);
wherein the HDS non-transitorily stores second computer instructions which, when executed by the host processor, instantiate a sink control engine (SXE) which configures the host device to perform sink control operations (SXO) comprising:
detecting the given sink device coupled to the host device;
determining if a given sink device control code, for the given sink device, is available in the HRDS; and
when the given sink device control code is available in the HRDS, the SXO further comprise:
receiving a user input via the host remote;
communicating the user input, by the host remote to the given sink device, using the given sink device control codes available in the HRDS; and
receiving an indication, from the given sink device, that the user input was received.

8. The system of claim 7, further comprising:
a content source coupled to the host device;
wherein the SXO further comprise:
detecting the content source coupled to the host device;
determining if content source control codes are available in the HDS; and
when content source control codes are available in the HDS, the SXO further comprise:
when a user input for the content source is received at the host remote:
receiving, by the host device from the host remote, a user input for the content source;
communicating, by the host device to the content source, the user input using at least one of the content source control code available in the HDS; and
receiving, by the host device from the content source, an indication that the user input was received.

9. The system of claim 8,
wherein, when content source control codes are unavailable in the HDS, the SXO further comprise:
downloading content source control codes from the staging server; and
saving the content source control codes in the HDS.

10. A non-transitory computer readable medium non-transitorily storing computer instructions which, when executed by a processor in a staging server, instantiates as a plurality of Cloud based services, a plurality of staging server retrieval engines (SSRE), including a given SSRE and a plurality of reminder SSREs, which configure the plurality of Cloud based services to independently and substantially simultaneously perform device code retrieval operations (DCRO) comprising:
associating the given SSRE with a given device provider;
associating each of the remainder SSRES with remainder device providers;
generating, by the given SSRE, a legacy device database identifying at least one given legacy device for the given device provider;
generating, by each of the remainder SSREs, remainder legacy device databases respectively identifying remainder legacy devices for the remainder device providers;
wherein the legacy device database and remainder legacy databases respectively include identifications of respective given legacy devices and remainder legacy devices; and
determining, for each of the given legacy devices and the remainder legacy devices, if at least one device code operable to control a given function of the given legacy device and the remainder legacy devices is respectively available in one at least of the legacy device database and the remainder legacy device databases.

11. The non-transitory computer readable medium of claim 10,
wherein the given device provider provides at least one audio-visual presentation device.

12. The non-transitory computer readable medium of claim 11,
wherein the legacy device database and the remainder legacy databases are provided by a staging server data store (SSDS) accessible to the given SSRE and each of the remainder SSREs.

13. The non-transitory computer readable medium of claim 12,
wherein the legacy devices identified in the legacy device database include at least one host device and at least one sink device previously discovered by the given SSRE.

14. The non-transitory computer readable medium of claim 13,
wherein, when a result of the determining does not result in an identification of a device code operable to control the given function of the given legacy device, the DCRO further comprise:
updating the legacy device database to identify the unavailable device code;
searching the Internet for an alternative device code that supports the given function of the given legacy device; and
when the alternative device code is found, verifying the alternative device code supports the given function of the given legacy device.

15. The non-transitory computer readable medium of claim 14,
wherein, the verifying that the alternative device code supports the given function of the given legacy device further comprises:
instantiating, by the staging server, as a second plurality of Cloud based services, a plurality of staging server testing engines (SSTE), including a given SSTE and a plurality of reminder SSTEs, which configure each of the second plurality of Cloud based services to independently and substantially simultaneously perform device code testing operations (DCTO) comprising:
substantially simultaneously testing, using a set of SSTEs selected from the given SSTE and the plurality of remainder SSTEs, the alternative device code for the given legacy device is interoperable with at least one of the remainder of legacy devices.

16. The non-transitory computer readable medium of claim 15,
wherein the substantially simultaneous testing includes:
a first testing including a first population of host devices couplable with the given legacy device;
a second testing including a second population of sink devices couplable with the given legacy device; and
a third testing including a third population including plurality of combinations and permutations of the first population of host devices with the third population of sink devices; and
outputting a testing results message based on first results obtained by the first testing, second results obtained by the second testing, and third results obtained by the third testing.

17. The non-transitory computer readable medium of claim 10,
wherein the DCRO further comprise:
repeatedly searching the Internet, by the given SSRE, for a new device announcement by the given device provider; and
when a new device announcement is found, adding, by the given SSRE, a new device identified in the new device announcement to a new device database maintained by a staging server data store (SSDS) accessible to the given SSRE.

18. The non-transitory computer readable medium of claim 17,
wherein the SSDS is accessible to each of the remainder SSRTEs.

19. The non-transitory computer readable medium of claim 17,
wherein, when the new device announcement for the new device is found, the DCRO further comprise:
instantiating, by the staging server, as a second plurality of Cloud based services, a plurality of staging server testing engines (SSTE), including a given SSTE and a plurality of reminder SSTEs, which configure each of the second plurality of Cloud based services to independently and substantially simultaneously perform device code testing operations (DCTO) for the new device comprising:
substantially simultaneously testing, using a set of SSTEs selected from the given SSTE and the plurality of remainder SSTEs, at least one device code for the new device is interoperable with at least one of the remainder of legacy devices.

20. The non-transitory computer readable medium of claim 19,
wherein the DCRO further comprise:
publishing, by the given SSTE to the remainder SSTEs, a new device notice;
publishing, by the given SSTE, the new device notice to one or more host devices;
receiving, by at least one of the given SSTE, one or more requests from the one or more host devices to retrieve a new device code for the new device; and
determining if the new device code for the new device is available in the SSDS.
